(19) United States
(12) Patent Application Publication
(10) Pub. No.: US 2014/0030403 A1
(43) Pub. Date: Jan. 30, 2014

(54) Stabilized masticated frozen dessert

(71) Applicant: David John Feldpausch, Sacramento, CA (US)

(72) Inventor: David John Feldpausch, Sacramento, CA (US)

(21) Appl. No.: 13/694,856

(22) Filed: Jan. 11, 2013

Related U.S. Application Data
(63) Continuation of application No. 12/291,171, filed on Nov. 7, 2008, now abandoned.

(51) Int. Cl. A23G 9/34

(52) U.S. Cl. CPC A23G 9/34
USPC 426/327; 426/565

(57) ABSTRACT

A process for preparing a frozen dessert having stabilized ice crystals to imitate the taste of ice cream, which process comprises: (A) providing a KEY ingredient, (B) adding a freeze inhibitor, in suitable amounts, and adequate sweetness to attain a stabilized starting freezing point of about 27° F. and melting point at about 17° F.; (C) adding a stabilizer in suitable amounts to create a microcrystalline ice particles; (D) rapidly freezing the mix until frozen solid at the temperature at which ice cream freezes; (E) masticating the frozen product to yield a soft serve dessert product for immediate consumption, said product having a contantometer rate significantly less than that of prior art desserts.

### FIELD OF THE INVENTION

This invention pertains to an ice cream consistency, with low or no fat containing dessert, which may be served as soft serve or as a regular frozen ice cream replacement.

### BACKGROUND OF THE INVENTION

U.S. Pat. No. 4,948,614 ('614) and U.S. Pat. No. 5,861,183 ('183), relate to a dessert that utilizes masticated banana as the base material to which other fruits can be added such as strawberry or cherry, as well as chocolate syrup, to provide a different flavor to the banana based dessert. That dessert requires special equipment that most dairies and creameries do not have, nor want due to the capital investment necessary to add this line of products to their dessert menu.

The '614 and '183 patents disclose ways to ease the cost to dessert providers by finding a way to make a dessert precursor. This is a specially pre-frozen block of the banana based dessert which can be stored in a central freezer, until the time of serving. Thus, reference is made to these patents. While this invention proved to be beneficial to dessert makers, there was still some resistance to a dessert being based on bananas.

Thus there is a present need for an invention that requires no specific base material. One can use anything: soy milk, Rice Dream™ (or other rice based milk substitute), soda pop, as well as fruit juice and juice drinks, to which other ingredients are added and subjected to the process of this invention.

### SUMMARY OF THE INVENTION

It is an object, therefore, to provide a dessert making process that permits the end product to be served as a soft serve dessert similar to ice cream, as well as in a fully frozen, ice cream consistency product.

It is a second object to provide a dessert that has stabilized ice micro-crystals, and has a similar freeze and melting range as ice cream, and thus simulates the mouth feel of ice cream.

It is a third object to provide a low cost but nutritious frozen dessert.

It is fourth object to make a frozen dessert that can have exotic flavors, such as kiwi and star fruit, as well as coconut, pumpkin, and sweet potato, among others.

It is a fifth object to provide a frozen dessert that has the flavor of an Icee™, or Slurpee™, but the consistency of an ice cream, such flavors being cherry cola, cola, ginger ale, and other sodas.

It is a sixth object to provide an ice cream-like product that is totally non-dairy for those persons who may be allergic to milk or an ingredient therein, or who keep a kosher household.

It is a seventh object to provide an ice cream or soft serve consistency product that is based on whole, 2%, 1%, or non-fat milk.

It is an eighth object to provide a frozen dessert that uses all of the fruit or berry, unlike sorbet which cannot use the entire fruit or berry including the seeds and skins, where most of the vitamins are to be found.

These and other objects will in part be obvious and will in part appear hereinafter.

The process of this invention involves one or more of at least one or more categories of bases, designated the KEY ingredient, namely whole fruit; soda pop of any flavor; milk and milk replacements with a flavorant added; tubers, roots and squash family products; and other edibles such as coconut milk, coconut meat which is diced as needed, cooked if not edible raw, mixed with a freeze inhibitor as may be needed, and a stabilizer as may be needed. Thus just about any human consumable foodstuff may be employed as a KEY ingredient. The mix is then frozen and masticated to yield a soft serve dessert product. The product can then be served for immediate consumption, or frozen again for serving later in time as an ice cream replacement. The reason for the statement “if needed,” as pertaining to the freeze inhibitor and the stabilizer is that certain fruits may naturally meet the requirements of this process without further additions. For example, certain bananas are naturally at a 27 Brix sweetness level so no inhibitor is needed.

The invention accordingly comprises the compositions possessing the features which are exemplified in the following detailed disclosure, and the process for making the compositions, the scope of both of which will be indicated in the appended claims.

For a fuller understanding of the nature and objects of the invention, reference should be made to the following detailed description, taken in conjunction with the accompanying drawings.

### BRIEF DESCRIPTION OF THE FIGURES

FIG. 1 is a diagrammatic illustration of the process of this invention, which is influenced in operation by the nature of the “KEY” ingredient.

FIG. 2 is a simplified and less detailed version of the process set forth in FIG. 1.

### DESCRIPTION OF THE PREFERRED EMBODIMENT

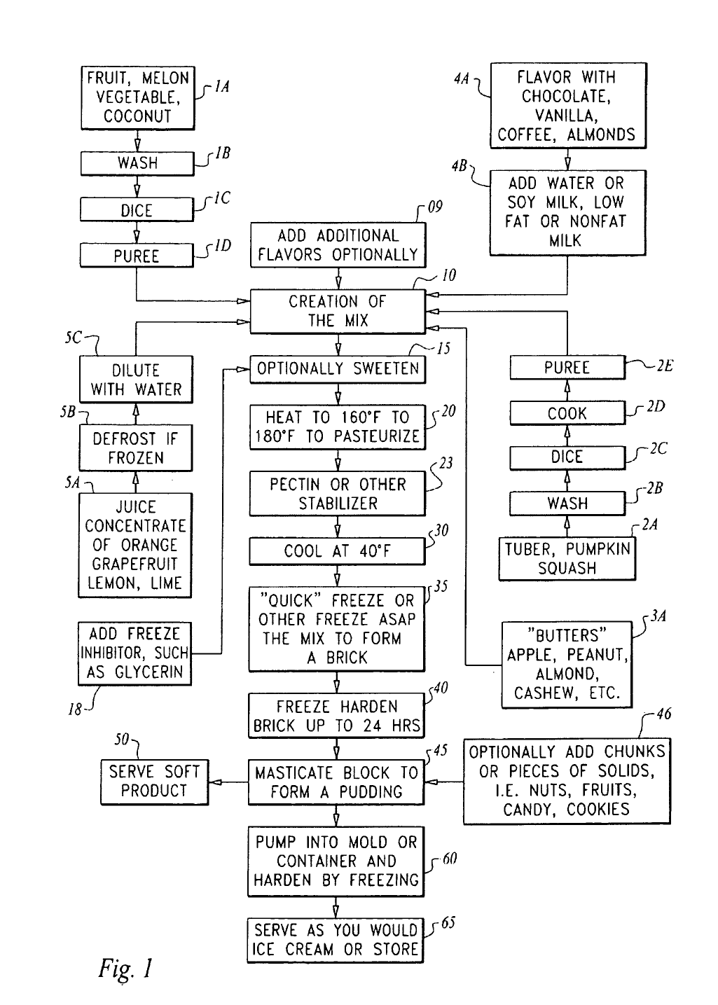

Reference is made to all of the boxes “A” with a number thereafter, namely; 1A, 2A, 3A, etc. These several boxes list KEY ingredients, which are all treated in the manner recited in the series of steps that lead to the center of the FIG. 1 for the commencement of the process.

### Specific Added Ingredients

### Freeze Inhibitor

Natural beet or cane sugar, honey, rice syrup or any sweetener can be employed as the freeze inhibitor and a sweetening agent. A Brix level of about 27 is considered desirable, in order to properly enable freezing starting at about 27° F. and melting at 17° F., no matter which type of sweetener is employed. It is within the skill of the art to determine the quantity of the sweetener product for the Brix sweetener level.

In order to keep the calorie content down, and to appeal to those who want to have a dessert yet avoid the sugar blues or blahs, the process of this invention may utilize non-nutritive sweeteners. Thus mention may be made of saccharine, or when combined with malto-dextrose as Sweet 'N Low™, aspartame such as is sold under the brand names Nutra-sweet™ or Equal™, and sugar derived products, such as Splenda™ or Stevia™. Suffice it to say that the products of this invention, in many instances, have original sweetness from the fruit or flavorant added, as well as from the added sweetener.

The melting point and freezing point is very important in making an ice cream-like product. The term “melts in your mouth” is commonly used for chocolate, but this concept also very important in the frozen desserts industry. Ice cream starts freezing at approximately 27° F. and melts at 17° F. Water freezes at 32° F., and the addition of sugar depresses the freezing range of a frozen dessert. The addition of other sweeteners also depresses the freezing point of a frozen dessert. Plain strawberries freeze at approximately 31° F. Thus, to make an ice cream-like product, a freeze inhibitor must be added to drop the freezing point. To use strawberries as an example, strawberries freeze at a lower temperature than water because of the natural sugars that are in the fruit, around 12 Brix. If you add sugar to raise the sweetness level to 20 Brix, this lowers the starting freezing temperature to approximately 29° F. If you raise the sweetness level further to 27 Brix, the new starting freezing temperature is approximately 27° F., with the melting temperature of approximately 17° F. the same as ice cream.

There are other materials, aside from sugar, that inhibit freezing. Salt, alcohol, and glycerin are some. These items can be used in making lower calorie or diet versions of the product. Again using strawberries as an example, the addition of one tablespoon of glycerin to ten ounces of strawberry, the new starting freezing point is 29° F. If you add two tablespoons of glycerin to ten ounces of strawberry, the starting freezing point is approximately 27° F. Likewise, if you add one tablespoon of glycerin and ¼ teaspoon of salt to ten ounces of strawberry, the new freezing point is approximately 27° F. Indeed, if you add sugar to ten ounces of strawberries to make 20 Brix and add one tablespoon of glycerin, you can inhibit the freezing temperature to approximately 27° F.

This shows that there are many ways to manipulate the freezing temperature, which of course could correspond to calorie count, depending upon the chosen freeze inhibitor.

Glycerin, also known as glycerol, which is non-caloric, and has a sweetness of about 60% of that of sucrose, serves a similar function to lower the freezing point. Care must be taken in the addition of a bulking agent (sweetener). Frozen desserts with too low a freezing point may become too soft when stored in a conventional home freezer, as the temperature is higher here than in a commercial freezer. Conversely, desserts can become too hard if the freezing point is too high. Thus, attention must be given to the total recipe of the frozen dessert.

### Stabilizer

As the stabilizer, the present invention can use many ingredients to form a hydrocolloid system. A hydrocolloid is defined as a colloid system wherein the colloid particles are hydrophilic polymers dispersed in water. A hydrocolloid has colloid particles spread throughout water, and depending on the quantity of water available that can take place in different states, e.g., gel or sol (liquid).

A common stabilizer that forms a hydrocolloid system is pectin. There are many different kinds of pectin that can be used singularly or mixed together to accomplish the desired consistency for the product. Also, all sorts of starches, such as corn, tapioca, roots, arrowroot, flours, or modified food starch may be employed. These have different procedures for mixing, some need to be mixed while hot, and others can be mixed cool. Some need a certain sugar level (Brix) to be activated, others do not.

The hydrocolloid system is critical to the present invention. By creating a hydrocolloid system the hydrophilic polymers of the colloids isolate small “pockets” of water inside a polymer lattice, such that when the temperature of the system is lowered, the water “pockets” individually freeze, thereby creating micro-crystals of ice. It is the microcrystalline particles of ice that ultimately leads to a smooth mouth feel of the product.

It is well known that smaller ice particle, in deserts, are more desirable. Liquid nitrogen has been used with ice creams in order to reduce the ice particle size. Even the traditional ice cream makers, which scrape frozen ice cream from the sides of a cooled container, mechanically shear the ice particles from the sides, mechanically breaking the ice particle formation.

Thus, by adding the stabilizer in the present invention, the small ice particles are created by isolated formation instead of a shearing action.

### The Process

Reference is made again to FIG. 1 at box 10, which begins the process of this invention. To get to this beginning of the process, one may utilize the KEY ingredients recited by groups in any of Boxes 1A, 2A, 3A, 4A, or 5A, and follow the procedural arrows of the box sets 1-5; namely 1A through 1D; 2A through 2E; 3A; 4A-4B; and 5A through 5C, respectively. From the last box of these single digit successions, one arrives at Box 10. Note also that flavorants, per box 9, can be added.

Once the mix is created, sweetener is optionally added to the desired level. As mentioned earlier herein, non-nutritive sweeteners may be utilized as well as cane or beet sugar. The mix should be sweetened to a level of between 26 and 28 Brix, for a wide range of consumer appeal. See Box 15.

The next step involves an addition, from Box 18 or Box 23. In Box 23, the pectin or other stabilizer is added in a within the skill of the art amount in grams for the batch size, while in Box 18, sufficient glycerin or another freeze inhibitor is added in conjunction to the pectin to stabilize the mix for the batch size. The amount of pectin utilized with or without glycerin or other freeze inhibitor remains the same, depending upon the KEY ingredient(s) employed in the creation of the mix. It is preferred to add the stabilizer after the pasteurization step of Box 20, per FIG. 1.

Some pectins require that sugar be the sweetener and perhaps a pH adjustment to carry out the intended addition purpose, others do not. Other pectins require the addition of calcium and a pH adjustment. For a no sugar added product, the latter type of pectin may be employed. While pectins are the preferred stabilizer, due to low price and easy availability, other food stabilizers, such as Xanthan gum or locust bean gum may be suitably employed in their traditional manner.

The created mixture, with the optional sweetener, is heated with the freeze inhibitor of Box 18 added, to about 180° F., to pasteurize the mix. See Box 20. The time to accomplish this will vary, depending upon the material of the vessel employed, and the surface area in contact with the heat source. It is believed that, for 5 gallons of mix, the pasteurization will take about 5 to 10 minutes in time to reach the temperature minimum for pasteurization.

Subsequent to the addition, or lack thereof, of the glycerin to the pectin and into the mix, at the elevated temperature, the mix is cooled down per Box 30 to about 40° F. This cooling can be carried out by placing the mix into a conventional refrigerator at about 40° F., for between about 7 and 10 hours, because freezing at cooler temperatures allows for easier freezing.

The next step is to freeze, per Box 35, the stabilized, freeze inhibited mixture. “Quick freezing”, which prolongs shelf life is recommended, but is not completely necessary. However quick freezing assists in the creating smaller ice crystals, relatively, and the smaller the ice crystals, the better the product. Ice crystals are not stationary but rather they grow in time. Therefore starting with the smallest possible ice crystals, will provide a longer shelf life both at home and prior to purchase, before a sandy or course mouth feel sets in. Care should also be given to the physical shape or configuration of the frozen product such that it can be easily masticated in the chosen masticator machine.

It is seen that in FIG. 1, it is suggested that the brick, which sometimes could be relatively soft yet frozen, based upon KEY ingredient(s), be freeze hardened. After this optional step, the brick is easier to physically handle for the mastication step. Of course there is a delicate balance between being overly hard which would require more effort for mastication, versus being “underly” hard which contributes to difficult handling prior to the mastication step. Such balance handling is within the skill of the art.

The frozen bricks or blocks are then subjected to a mastication step per Box 45. To carry out the mastication, the frozen blocks are removed from their containers using a fork or other implement, but without applying heat and placed into the masticator. Typical machines that can be used for this process include the Champion Juicer, among others available in the market place. Mastication or particle reduction is carried out for as long as necessary, until the frozen mix has achieved a pudding-like or soft-serve state. The mastication of the frozen stabilized mixture completely scrambles the frozen molecules to create a creamy textured product, similar to ice cream. During the course of the mastication, an overrun of about 10%-15% is achieved, but this can be changed a bit if desired. Overrun is a term known to the art as an increase in volume due to entrained air. While the inventor hereof has utilized a modified Champion brand juicer for the mastication, any machine that can successfully reduce the particle size to produce a pudding like product may be employed. In essence, the mastication step reduces the frozen particle size to the desired pudding like product.

Once the pudding consistency has been reached, a portion may be put into a bowl or cone and immediately served to a hungry recipient, per Box 50. Unused product in the pudding state should be refrigerated to prevent breakdown to a liquid. At this point in time, chunks or pieces of fruit, nuts, candy, chocolate, or coconut can be folded or mixed into the pudding per Box 46, if desired.

In the alternative, once the pudding consistency is reached, the pudding can be re-frozen at a temperature of about 10° F. or colder, and the “left over” pudding soft serve from Box 50, and then frozen hard in a home freezer to form an ice cream consistency product. See Box 60.

Alternatively, the creamy pudding can be pumped into a mold, into which a stick may be placed at a suitable time to form an on-the-stick product, and hardened in an immersion or blast freezer to solidify the random and scattered molecules. The result is a product that is creamy similar to ice cream but which does not employ typical ice cream or sorbet ingredients. It is ready for service in a cone or cup, per Box 65.

The reader is advised that “blast,” “immersion,” “nitrogen,” and “plate” freezers are well known to skilled artisans in the ice cream and frozen confectionary industry. All of these freezers are readily available in the marketplace. See also U.S. Pat. No. 6,109,056, of Feldpausch issued Aug. 29, 2000, for discussion of an immersion freezer.

Prior to discussing specific examples of this process, the 3 tables aforementioned are presented. It is to be noted that ice cream starts to freeze as noted at about 27° F. and melts at about 17° F., and thus to simulate an ice cream product, the product must have the similar freeze and melting point. The three tables below depict temperature in the vertical column and in the horizontal 10 oz. of plain strawberries are shown at its starting freeze point, at (A), while B, C, D, and E each pertain to the starting freeze point of on the chart of 10 oz strawberries with the recited amounts of the freeze inhibitor and/or stabilizer.

In all instances A=10 oz strawberries at 12 Brix, which represents no added sweetener.

The same volume of unsweetened strawberries was used in experiments B through N.

These 3 tables illustrate the role of freeze inhibitors in affecting the freeze point of fruit. While only strawberries have been recited experiments with other fruits yield similar types of results. Glycerin has also been replaced by other freeze inhibitors, such as maltodextrin, with similar results. Sorbitol and polydextrose can also be added to inhibit the freeze point of the KEY ingredient to raise or lower the temperature to reach the desired 27° F. starting freeze point.

The following Examples utilize various types of the KEY ingredients as shown in FIG. 1. These examples are not to be considered as limiting but are only typical of the products that can be prepared according to this process. In all of these examples, the percentages are by weight, not by volume.

### EXAMPLE I

### Fruit (Sugar Added) Non-Dairy, with Sugar

Fruit 75% to 88%
Sugar 12% to 23%
Pectin 0.25% to 1.75%

### EXAMPLE II

### Fruit (No Sugar Added)

Fruit 80% to 92%
MPS 2% to 15% maltodextrin, polydextrose, sorbitol
Glycerin 1% to 17%
Splenda® 0.5% to 4%
Pectin 0.25% to 1.75%

### EXAMPLE III

### Non-Fat Milk Flavored with Vanilla

Milk 73% to 80%
Sugar 14% to 24%
Vanilla 0.5% to 2.5%
Pectin 0.25% to 1.75%

### EXAMPLE IV

### Non-Fat Milk with Fruit

Milk 36% to 45%
Fruit 36% to 45%
Sugar 13% to 23%
Pectin 0.25% to 1.75%

### EXAMPLE V

### Non-Dairy Milk with Vanilla Flavoring

Soy milk 78% to 88%
Sugar 9% to 19%
Vanilla 0.1% to 3%
Pectin 0.25% to 1.75%

### EXAMPLE VI

### Fruit Juice (Fresh or Canned)

Fruit Juice 77% to 89%
Sugar 9% to 19%
Pectin 0.25% to 1.75%
Inulin 0.1% to 1%

### EXAMPLE VII

### Any Flavored Soda or Tea Liquid

Soda/tea 77% to 86%
Sugar 12% to 23%
Pectin 0.25% to 1.75%
Inulin 0.1% to 1%

### EXAMPLE VIII

### Strawberry Peanut Butter

Strawberries 68% to 78%
Peanut butter 7% to 15%
Sugar 10% to 20%
Pectin 0.25% to 1.75%

### EXAMPLE IX

### Celery Peanut Butter

Celery 68% to 78%
Peanut Butter 7% to 15%
Sugar 10% to 20%
Salt 0.10% to 1.5%
Pectin 0.25% to 1.75%

### EXAMPLE X

### Cranberry

Canned Whole Cranberry Sauce 60% to 80%
Sugar 20% to 40%
Water 1% to 20%

Note the lack of need for added pectin in this Example, due to the high naturally occurring pectin content, which pectin acts as a stabilizer.

### EXAMPLE XI

### Candied Yams

Yams 60% to 85%
Water 10% to 40%
Sugar 12% to 30%
Modified Food Starch 0.25% to 1.75% (A stabilizer)
Spices Suitable amount to taste, clove, and/or nutmeg, and/or cinnamon

It is to be noted that while EXAMPLE III utilized flavored non-fat milk, unflavored non-fat milk as well as flavored and unflavored 1% and 2% fat milk will give similar results when employed in the formulae of both EXAMPLE III and EXAMPLE IV.

Moreover, results of a Bostwick test performed with a Consistometer to measure the viscosity flow of the melting rate (drips) of frozen desserts clearly indicates that product produced according the present invention have substantially different physical properties from those of prior art deserts.

The Consistometer was set at a constant of 6° slope. Room temperature was a constant 80° F. ½ ounces of frozen product was placed into the closed chamber of the Consistometer with clock starting at the opening of the chamber door. All frozen product were at same temperature of 0° F. when placed into Consistometer.

Five frozen products were tested; Strawberry Ice Cream, Strawberry Sorbet, Strawberry Dulin Ice Cream Freezer, Strawberry Dulin Frozen Masticated, Invented Strawberry and Invented Strawberry No Sugar. The Dulin product was made to specs of Dulin patent Example 1, Strawberry were made either in an ice cream freezer or frozen then masticated.

The ingredients of each product tested are as follows:

Strawberry Ice Cream; cream, skim milk, strawberries, sugar, egg yolks.

Strawberry Sorbet; water, strawberries, sugar, corn syrup, lemon juice concentrate, pectin, elderberry concentrate, chokeberry juice concentrate, natural flavor.

Dulin Strawberry; water, corn syrup, dextrose, strawberry puree, sucrose, citric acid, stabilizer, emulsifier.

Invented Strawberry, whole strawberries, sugar, pectin.

Invented Strawberry No Sugar; whole strawberries, poly dextrose, sucralose, pectin.

Test Results

Strawberry Ice Cream

5 Minutes 2 cm

10 Minutes 20 cm

Strawberry Sorbet

5 Minutes 2.5 cm

10 Minutes 16 cm

Dulin Strawberry Ice Cream Freezer

5 Minutes 1.5 cm

9 Minutes 24 cm

Dulin Strawberry Frozen Masticated

5 Minutes 6 cm

10 Minutes 23 cm

Invented Strawberry

5 Minutes 0.5 cm

10 Minutes 1 cm

20 Minutes 2.75 cm

Invented Strawberry No Sugar

5 Minutes 0.5 cm

10 Minutes 1 cm

20 Minutes 2.75 cm

This clearly shows that the Invented Strawberry and Invented Strawberry No Sugar have unique melting (drip) rates that are substantially different from those of prior art deserts.

### Conclusion

The process of this invention can make an ice cream like product that does not rely on fat for its creaminess and at the same time utilizes non-dairy ingredients. The invention incorporates not just typical non-dairy, but rather whole fruit, including the seeds and skins, but not pits like apricot or peach. The type of seeds intended are seeds the size of raspberry, pomegranate, blackberry, pear, or apple. The process of this invention can also use the skins of the fruit. For instance, blueberries, grapes, and apples need not be peeled. The process can also use vegetables and tubers, such as yam and sweet potato, or even yucca—savored by people from the Caribbean countries. It is well known that most of the vitamins and minerals are stored in the seeds and skins of the fruit or vegetable. Therefore, utilizing the whole fruit achieves a more wholesome, natural, and nutritious product. The most famous of the roots that may be employed as a KEY ingredient are ginger and ginseng. Members of the squash family include pumpkin and spaghetti squash.

When one uses a traditional ice cream freezer to make a frozen dessert, something as small as a strawberry seed can be detrimental to the operation of the freezer. For this process, the mixture need not be thin and free flowing. Here, even peanut and other nut butters can be used as the KEY ingredient. Thus, not only is a uniquely flavored product made available to kids and adults alike, but meal replacements of a very tasty nature chock full of vitamins and minerals can be had in an easy to eat format.

The major difference between this product and sorbet is that sorbet is prepared in an ice cream machine. Sorbet starts as a liquid and is slowly frozen and aerated. This series of product\s are not made on traditional ice cream machinery.

For products such as frozen lemonade and other high water content related products that are made in an ice cream machine, the water content turns into small ice crystals which can be felt on the tongue.

In contrast, here the ice crystals are virtually undetectable. By stabilizing the liquid and then freezing the mass in a rapid manner, followed by mastication, the ice crystals that are present are completely broken away into small,groups. By maintaining the cold temperature, before rehardening, the micro-crystals of ice are inhibited from chain reformation, which would yield a very hard product like an ice cube. Instead a product of ice cream like consistency is formed.

Thus there can be made a frozen dessert from such diverse fluids as green tea, coffee, KoolAid®, Coca Cola®, and Sprite® among others.

While any of the KEY ingredients be they as solids or liquids, can be used in combinations, certain combinations of these are well known. Thus strawberries and kiwi and strawberries with banana may be mentioned along with Cherry and cola soft drinks, and mint with chocolate and pineapple with coconut may be mentioned. Other unique flavor combinations include coconut milk+vanilla, and mango pineapple among others.

If desired, subsequent to the mastication step, chunks of edibles may be added to enhance the taste experience. Mention may be made of Oreo® bits, M & M® candies and chocolate, fruit chunks, such as pieces of cherry and other fruit such as peach, miniature marshmallows and the like, per BOX 46.

In this era of adult onset diabetes and obesity in people of all ages, the products of this invention offer a nutritionally beneficial, pleasurable to eat product. Basically, the two formats of the products of this invention utilize whole fruit or vegetable to which a little sweetener is added, rather than a bit of fruit, and a large amount of sweetener with milk or water fluid, as is the case for traditional ice cream or sorbet.

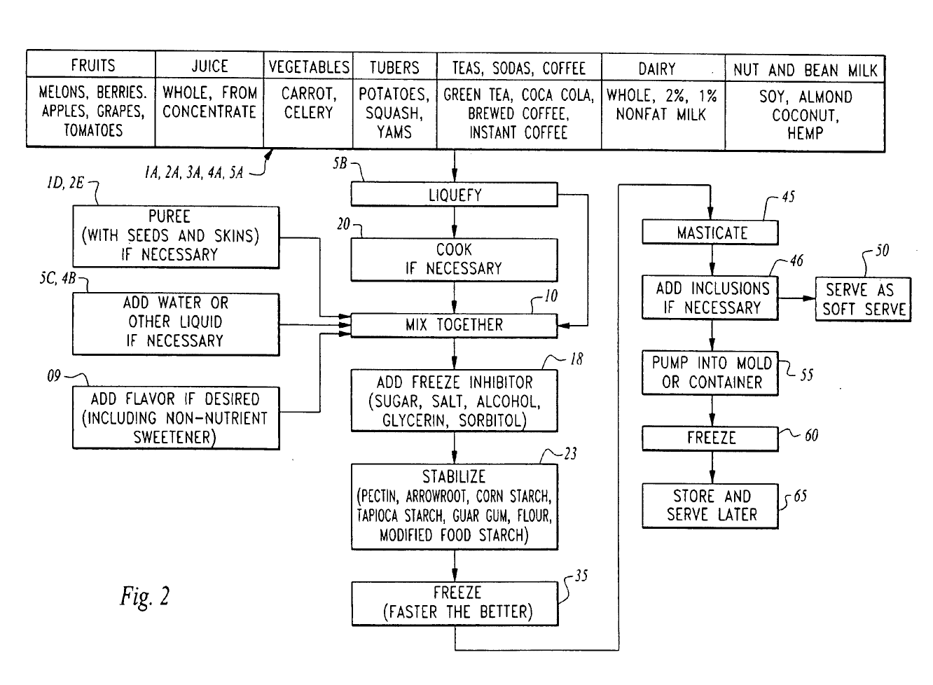

Rather than adding the wording “if necessary”, to Box 15 and to Box 23 of FIGS. 1 and 2, it should be readily recognized by those skilled in the art that certain KEY ingredients inherently contain adequate stabilizer and/or adequate sweetener to not require the addition of a stabilizer or a freeze inhibitor. Mention may be made of such KEY ingredients as cranberries and bananas.

It is seen therefore, that there has been disclosed a product that has a smooth mouth feel much like that of fat rich ice cream, and the process for making it, which product may be made with non-fat, reduced fat, or whole milk, or no milk at all, as may be desired.

Whatever path is taken, the result is a good tasting soft-serve product or as a creamy ice cream replacement product as may be desired.

Since certain changes may be made in the herein disclosed process and product without departing from the scope of the invention involved, it is intended that all matter contained in the about description and shown in the accompanying drawings shall be interpreted as illustrative only and not in a limiting sense.

TABLE I

| | | | | | |
|---|---|---|---|---|---|
| 25′ | | | | | |
| 26′ | | | | | |
| 27′ | | | • | • | |
| 28′ | | | | | • |
| 29′ | | | | | |
| 30′ | | • | | | |
| 31′ | • | | | | |
| 32′ | | | | | |
| | A | B | C | D | E |

Wherein
A = plain strawberries with 12 Brix sweetness
B = plain strawberries with 20 Brix sweetness
C = plain strawberries with 27 Brix sweetness
D strawberries @ 20 Brix sweetness + 1 tablespoon glycerin
E strawberries, no added sugar. Y. teaspoon of salt (unacceptable last)

TABLE II

| | | | | | | |
|---|---|---|---|---|---|---|
| 23° | | | | • | | |
| 24° | | | | | | |
| 25° | | | | | | • |
| 26° | | | | | | |
| 27° | | | • | | | |
| 28° | | | | | • | |
| 29° | | • | | | | |
| 30° | | | | | | |
| 31° | • | | | | | |
| 32° | | | | | | |
| | A | F | G | H | I | J |

Wherein
A = 10 oz. plain strawberries with 12 Brix sweetness
F = strawberries + 1 tablespoon glycerin
G = strawberries + 2 tablespoons glycerin
H = strawberries + 3 tablespoons of glycerin
I = strawberries + 1 tablespoon glycerin + ¼ teaspoon table salt
J = strawberries + 1 tablespoon glycerin + ¾ teaspoon table salt

TABLE III

| | | | | | |
|---|---|---|---|---|---|
| 23° | | | | | |
| 24° | | | | | |
| 25° | | | | | • |
| 26° | | | | | |
| 27° | | | • | | |
| 28° | | • | | • | |
| 29° | | | | | |
| 30° | | | | | |
| 31° | • | | | | |
| 32° | | | | | |
| | A | K | L | M | N |

Wherein
A = 10 oz. plain strawberries with 12 Brix sweetness
K = strawberries + 1 teaspoon table salt
L = strawberries + 1.5 teaspoons of table salt
M = strawberries + ¼ teaspoon salt + 1 tablespoon glycerin
N = strawberries + ¾ tablespoon table salt + 1 teaspoon glycerin

I claim:

1. A process for preparing a frozen dessert having stabilized ice crystals to imitate the taste of ice cream, which process comprises:
(A) providing a KEY ingredient,
(B) adding a freeze inhibitor, in suitable amounts, and adequate sweetness to attain a stabilized starting freezing point of about 27° F. and melting point at about 17° F.;
(C) adding a stabilizer in suitable amounts to create a microcrystalline ice particles;
(D) rapidly freezing the mix until frozen solid at the temperature at which ice cream freezes;
(E) masticating the frozen product to yield a soft serve dessert product for immediate consumption, said product having a contantometer rate significantly less than that of prior art desserts.

2. The process of claim 1 wherein the stabilizer forms a hydrocolloidal system.

3. The process of claim 1 wherein the KEY ingredient is one or more whole fruit, and said fruits include raspberry, pomegranate, blackberry, pear, apples, blueberries, grapes, and strawberries.

4. The process of claim 1 wherein the KEY ingredient is selected from the group consisting of edible tubers, roots and squashes.

5. The process of claim 1 wherein the KEY ingredient is a liquid selected from the group consisting of tea, cola, flavored carbonated drinks, and fruit juices and mixtures thereof.

6. A process for preparing a frozen dessert having stabilized ice crystals which comprises:
A) providing at least one KEY ingredient selected from the group consisting of solids and liquids of human consumable foodstuffs, and mixtures thereof, wherein if solid , the at least one KEY ingredient have been diced and pureed, and if not chewable in the raw state, pre-cooked, and
wherein if the at least one KEY ingredient is liquid, when concentrated is diluted prior to mixing, and if not concentrated, is added, directly into the mixer for mixing;
B) sweetening the mix of at least one KEY ingredient as necessary to achieve a Brix level of about 26,
C) preferably heating the mix to about 180° F., to pasteurize the mixture;
D) adding a stabilzer in an amount sufficient to create a hydrocolloidal system;
E) cooling the mix to about 40° F.;
F) freezing the mix as fast as possible to minimize the formation of large ice crystals in a container;
G) freeze hardening the frozen container of mix;
H) masticating the hardened mix to reach a pudding consistency; and
I) serving the product as a soft-serve ice cream substitute, said product having a contantometer rate significantly less than that of prior art deserts.

7. The process of claim 6 including the steps of containerizing the masticated mix, and hard freezing it to serve as an ice cream substitute.

8. The process of claim 6 wherein steps F) and G) are carried out as one step by the technique known as “quick freezing”.

9. The process of claim 6 wherein the freeze inhibitor is selected from the group consisting of glycerin, polydextrose, table salt, sorbitol, sugar and maltodextrin and mixtures thereof

10. The process of claim 6 wherein the freeze inhibitor is added in an amount to achieve a starting freeze point of about 27° F. and melting point of about 17° F.

11. The process of claim 6 wherein pectin and a freeze inhibitor are added to ensure the desired freeze and melting point to simulate ice cream.

14. The process of claim 6 wherein no freeze inhibitor is needed to reach the about 27° F. freeze point, due to the nature of sweetened KEY ingredient(s).
